(19) United States
(12) Patent Application Publication
(10) Pub. No.: US 2020/0358613 A1
(43) Pub. Date: Nov. 12, 2020

(54) IMPROVEMENTS IN AND RELATING TO REMOTE AUTHENTICATION DEVICES

(71) Applicant: BAE Systems plc, London (GB)

(72) Inventor: Mark Timothy Bryant, Christchurch (GB)

(73) Assignee: BAE Systems plc, London (GB)

(21) Appl. No.: 16/764,415

(22) PCT Filed: Nov. 16, 2018
(86) PCT No.: PCT/GB2018/053325

§ 371 Date: May 15, 2020

(30) Foreign Application Priority Data
Dec. 5, 2017 (GB) 1720253.2

(51) Int. Cl. H04L 9/32; H04L 9/08

(52) U.S. Cl. CPC H04L 9/3228; H04L 9/3242; H04L 9/0869

(57) ABSTRACT

A remote authentication device includes a memory. The memory includes a one time pad comprising a series of bits. The memory includes circuitry arranged to retrieve a plurality of the bits from the one time pad. The circuitry is arranged to form a key from the plurality of bits and to use the key in a hash to generate an authentication code. The retrieval of the bits, forming of the key, and generation of the authentication code are repeated a plurality of times using a different plurality of bits from the one time pad.

### FIELD OF THE INVENTION

This invention relates to the field of remote authentication devices.

### BACKGROUND ART

Current remote authentication devices such as bank secure keys and RSA SecurID® use a secret key that is hardcoded into the device and known to a central server. The secret key K and another factor T (usually a timestamp derived from the time at which a request for an authentication code occurs, and/or a counter that increments each time a code is requested) are passed as inputs to an algorithm that generates a long length output F(K,T). The output F is used to generate a variable length (typically 6-8 digit) hash that the remote user transmits to the server to authenticate his or her self. The server will use the same key, factor and algorithm in generating its own hash and, if the hash it generates matches the hash received from the users, the user is authenticated.

In public or asymmetric key encryption methods, a public key can be used by anyone to encrypt a message, but only the holder of a corresponding private key can decrypt the message. In recent years, the asymmetric key approach has dominated the field of encryption, as symmetric methods are harder to scale to the large data volumes involved in modern telecommunications. However, there is growing concern that quantum computing will render present asymmetric key distribution methods to be insecure.

In current commercial remote authentication devices, such as those used to authenticate transactions between a bank and its customer, the secret key known only to the remote server (e.g. bank) and hardcoded in the user's (e.g. customer's) device is typically a fixed key of 128 bits. With the development of faster processors and (as just mentioned, the emerging capability of quantum computing), as the time of the transactions, the function and the hash used have to be considered known by an attacker. By knowing these variables there is a real danger that this type of secure authentication will become obsolete in the future with the emergence of quantum computing. Furthermore, storing the key in the device makes the device vulnerable if the device is subsequently captured and compromised successfully.

As described above, many remote authentication devices use timers or counters to provide a second factor for use in generating the authentication code, and it is necessary for those timers or counters to be kept synchronized, which can be problematic.

Furthermore, present methods can be vulnerable to malware, for example malware designed to enact a “man-in-the-middle” attack.

It would be advantageous to provide a remote authentication device in which one or more of the aforementioned disadvantages is eliminated or at least reduced.

### SUMMARY

Briefly and in general terms, the present invention provides apparatus directed towards improving remote authentication devices. In example embodiments, a one time pad (OTP) is used to replace the fixed key of prior art devices. The OTP comprises a series of bits, preferably a random or pseudo-random series, that are used to generate a series of keys which are in turn used to generate values that can authenticate the user with the server, and can optionally also provide keys for other exchanges that follow the initial authentication. In preferred but optional embodiments, on generating the key, the bits used to generate it are securely deleted, which prevents any reuse of the OTP occurring and removes the possibility of successfully reverse engineering the OTP if the authentication device is subsequently compromised.

A first aspect of the invention provides a method of remote authentication, comprising:
(i) forming a key from a plurality of bits from a one time pad;
(ii) using the key to generate an authentication code;
(iii) receiving an authentication code;
(iv) performing the authentication by comparing the generated authentication code with the received authentication code; and
(v) repeating steps (i) to (iv) a plurality of times using a different plurality of bits from the one time pad.

A second aspect of the invention provides a method of remote authentication, comprising:
(i) forming a key from a plurality of bits from a one-time pad;
(ii) using the key to generate an authentication code;

(iii) transmitting the authentication code; and

(iv) repeating steps (i) to (iii) a plurality of times using a different plurality of bits from the one time pad.

A third aspect of the invention provides a method of remote authentication, comprising:
a user:
(i) forming a key from a plurality of bits from a one-time pad;
(ii) using the key to generate a first authentication code;
(iii) transmitting the first authentication code to a server remote from the user; and
the server:
(iv) forming a key from a plurality of bits from a one time pad identical to the one time pad used by the user;
(v) using the key to generate a second authentication code;
(vi) receiving the first authentication code from the user;
(vii) performing the authentication by comparing the second authentication code with the first authentication code; and
(viii) repeating steps (i) to (vii) a plurality of times using a different plurality of bits from the one time pads.

(The steps of the methods may be carried out in an order different from that set out above. For example, the server may receive the authentication code before generating the authentication code with which it is to be compared.)

A fourth aspect of the invention provides a remote authentication device, comprising:
(i) a memory including a one time pad comprising a series of bits;
(ii) circuitry arranged to:
   a. retrieve a plurality of the bits from the one time pad,
   b. form a key from the plurality of bits,
   c. use the key to generate an authentication code,
   d. repeat steps (a) to (c) a plurality of times using a different plurality of bits from the one time pad.

According to a fifth aspect of the present invention, there is provided a smart card comprising the remote authentication device according to the fourth aspect.

It will be appreciated that features described in relation to one aspect of the present invention can be incorporated into other aspects of the present invention. For example, an apparatus of the invention can incorporate any of the features described in this disclosure with reference to a method, and vice versa. Moreover, additional embodiments and aspects will be apparent from the following description, drawings, and claims. As can be appreciated from the foregoing and following description, each and every feature described herein, and each and every combination of two or more of such features, and each and every combination of one or more values defining a range, are included within the present disclosure provided that the features included in such a combination are not mutually inconsistent. In addition, any feature or combination of features or any value(s) defining a range may be specifically excluded from any embodiment of the present disclosure.

### BRIEF DESCRIPTION OF THE DRAWINGS

Embodiments of the invention will now be described by way of example only and with reference to the accompanying drawings.

FIG. 1 is a schematic drawing of a first example remote authentication device according to the invention.

FIG. 2 is a schematic drawing of a second example remote authentication device according to the invention.

FIG. 3 is a portion of an example one time pad for use in the remote authentication devices of FIG. 1 or FIG. 2.

FIG. 4 is a schematic flow diagram showing steps in an example method according to the invention.

FIG. 5 is a schematic drawing of an arrangement of shift registers used in an example embodiment of the invention.

FIG. 6 is a block diagram showing operations of a processor used with the shift register arrangement of FIG. 5.

FIG. 7 is a flow chart showing steps in an example method of operating the apparatus of FIGS. 5 and 6.

FIG. 8 is a block diagram illustrating how an example embodiment of the present invention can thwart a “man in the middle” attack.

For convenience and economy, the same reference numerals are used in different figures to label identical or similar elements.

### DETAILED DESCRIPTION

Embodiments are described herein in the context of approaches to improve remote authentication devices. Those of ordinary skill in the art will realize that the following detailed description is illustrative only and is not intended to be in any way limiting. Other embodiments of the present invention will readily suggest themselves to such skilled persons having the benefit of this disclosure. Reference will be made in detail to implementations as illustrated in the accompanying drawings.

As set out above, the first aspect of the invention provides a method of remote authentication in which a key is formed from a plurality of bits from a one time pad. The key is used to generate an authentication code. An authentication code is received. The authentication is performed by comparing the generated authentication code with the received authentication code. The steps of the method are repeated a plurality of times, each time using a different plurality of bits from the one time pad.

As set out above, the second aspect of the invention provides a method of remote authentication in which a key is formed from a plurality of bits from a one-time pad. The key is used to generate an authentication code. The authentication code is transmitted. The steps of the method are repeated a plurality of times, each time using a different plurality of bits from the one time pad.

As set out above, the third aspect of the invention provides a method of remote authentication in which a user forms a key from a plurality of bits from a one-time pad. The user uses the key to generate a first authentication code. The user transmits the first authentication code to a server remote from the user. The server forms a key from a plurality of bits from a one time pad identical to the one time pad used by the user. The server uses the key to generate a second authentication code. The server receives the first authentication code from the user. The server performs the authentication by comparing the second authentication code with the first authentication code. The user and the server repeat the steps of the method a plurality of times, each time using a different plurality of bits from the one time pads.

The authentication code may be transmitted to a server.

The authentication code may be transmitted in plaintext.

Unlike use of asymmetric keys in present methods of remote authentication, use of an OTP is intrinsically resistant to breaking by quantum computers. Also unlike many present methods of remote authentication, independent synchronization of clocks or counters, between the user and the remote server is not necessary: a starting point in the OTP can be transmitted in plaintext with the authentication code.

Furthermore, in contrast to prior-art methods, the present method is less vulnerable to malware on a remote computer with which the user is interacting.

The key may be used in a hash to generate the authentication code.

The authentication code may be generated by applying a logical operation, for example a XOR, to the key and a plurality of bits, from the OTP, not forming the key.

The authentication code may be formed directly from the key, for example the key may be the authentication code.

The method may include, subsequent to generating the authentication code, the steps of forming a key from a plurality of bits (different from those used to form the authentication code) from the one time pad and using the key to encrypt a message.

As set out above, the fourth aspect of the invention provides a remote authentication device. A memory in the device includes a one time pad comprising a series of bits. Circuitry in the device is arranged to: retrieve a plurality of the bits from the one time pad; form a key from the plurality of bits, use the key to generate an authentication code; and repeat those steps a plurality of times using a different plurality of bits from the one time pad.

The circuitry may be arranged to transmit the authentication code. The circuitry may be arranged to receive an authentication code and to perform an authentication by comparing the generated authentication code with the received authentication code.

The circuitry may include a microprocessor.

The one time pad will include sufficient bits to form a plurality of different keys. The one time pad may be very much larger, for example one or more orders of magnitude larger, than the 1024 and 2048 bit keys used in present remote authentication devices. Thus, the one time pad may include more than 1 megabit of data. For example, the one time pad may include more than 100 megabits, more than 1 gigabit, more than 500 gigabit, more than 1 terabit or even more than 100 terabits of data for forming the keys; thus, preferably, a very large number of keys can be formed from the bits stored in the one time pad.

The bits used to form the key may be deleted automatically from the one time pad. The automatic deleting may be done before transmission of the authentication code. The automatic deleting may be done after transmission of the authentication code. The automatic deletion may be done immediately after each bit of the key is retrieved from the one time pad.

The one time pad may be loaded into a serial shift register. The bits forming the key may be shifted from the serial shift register. The bits left vacant by the shifting may be populated with zeros, ones or a random or pseudo-random sequence of zeros and ones. Thus the bits forming the key may be removed from the serial shift register and replaced in the serial shift register by the zeros, ones or sequence of zeros and ones.

The number of bits retrieved to form the keys may be the same for each iteration of the method, i.e., each key formed may be of the same length. Alternatively, different length keys may be formed in different iterations. The key length may be transmitted, as part of or in addition to the authentication code. The key length may be selected by a pseudo-random algorithm.

The plurality of bits used to form the key may be retrieved from a contiguous portion of the one time pad, i.e., they may be stored together in sequence in the one time pad.

The method may include recording (for example in a register) a current start point in the one time pad, from which the plurality of bits are retrieved, and then updating the current start point to be the bit next following the retrieved bits in the one time pad.

The start point may be transmitted, as part of or in addition to the authentication code and/or key length (if transmitted).

The receiver of the authentication code may also therefore receive the start point and/or key length, for use in retrieving the correct plurality of the bits from the one time pad.

The authentication code may be transmitted by a user or device to a server for authentication of the user or device. The one time pad may be provided in a module in the server and the remote authentication device may be authenticated with the server before activation of the OTP module. That will help to ensure that the OTP is matched to the correct user/device.

If a user is being authenticated, the authentication code may be presented to the user on a display. The user can then input the authorization code into a website, app or other interface to authenticate themselves. Where appropriate, the starting address and/or the key length is also presented to the user on the display.

The remote authentication device may be protected by a personal identification number PIN, which may be unique to each user. The remote authentication device may be configured to delete the one time pad from memory if the PIN is incorrectly input a preselected number of times.

If a device is being authenticated, the starting point, key length and hash may be generated automatically when the device receives a query across a network connection.

The memory including the one time pad may be, for example, an Electrically Erasable Programmable Read Only Memory (EEPROM).

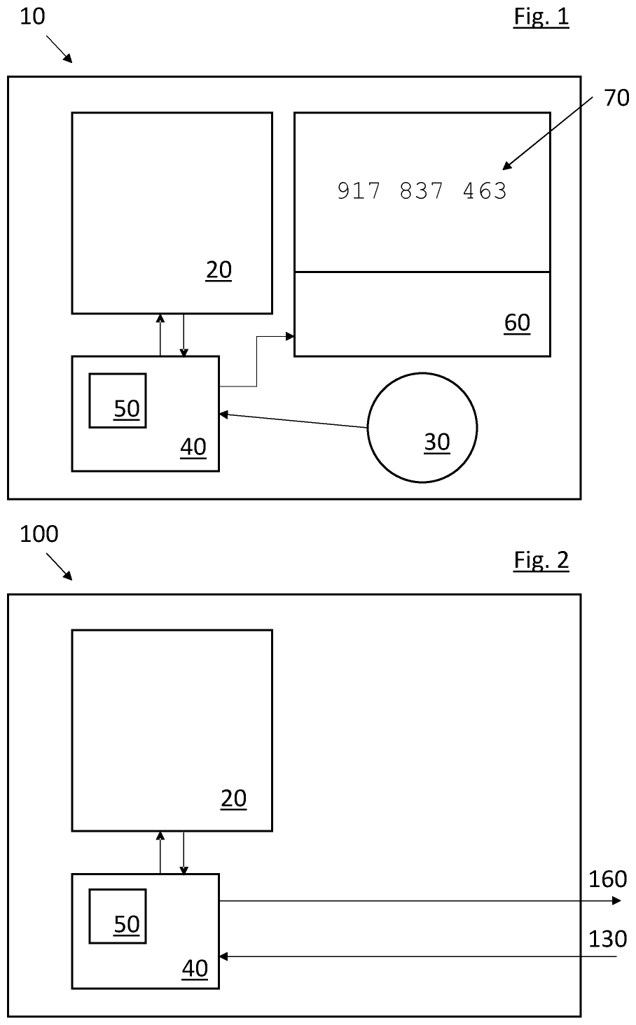

A first example embodiment (FIG. 1) is an example remote authentication device 10, for authentication of a person. The device 10 includes an EEPROM 20, an activation button 30, a microprocessor 40 including a register 50, and a display 60. The EEPROM 20 stores a one time pad. When a user wishes to initiate authentication, for example in response to a prompt from a website, the user presses the button 30. That causes the processor 40 to retrieve a start position from the register 50 and to generate a random length (between a minimum and a maximum length). The processor 40 then retrieves from the one time pad in the EEPROM 20 the sequence of bits of the generated length that starts at the start position. The processor 40 hashes the retrieved sequence of bits to produce a sequence of numbers. The processor 40 concatenates the start position, length and sequence of numbers and sends the resulting sequence to a display 60, where it is displayed as an authentication code 70.

The processor then deletes (by overwriting) the retrieved bits from the one time pad. An OTP is more secure against subsequent capture if the key is deleted as it is used. Technologies such as Electrically Erasable Programmable Read Only Memory(EEPROM) can be used to store the OTP. The deletion mechanism will control the OTP device so it removes the bits used after or as they are retrieved. An example of an implementation would be a serial shift register, in which the bits are shifted based on the pulses the shift register receives. Once shifted the new bits are populated by 0's.

The processor 40 then stores the new start position (i.e. the address of the next bit following the now-deleted bits in the one time pad) in the register 50.

The user reads the authentication code from the display 60 and provides it to an authenticating server (not shown). The transmission of the start bit and key length ensures that the remote device 10 and the server are always synchronized (lack of synchronization is one of the main problems with current remote authentication devices).

The location and length in the OTP is not a secret and can therefore be sent in the clear to allow synchronization. The authenticating server extracts the start positions and length from the authentication code 70 and retrieves from its own identical copy of the one time pad the sequence of bits having that length that starts at the start position. The processor 40 hashes the retrieved sequence using the same hash as the device 10 used and thereby obtains the same sequence of numbers as are in the authentication code 70. This authenticates the user.

A second example embodiment (FIG. 2) is a second remote authentication device 100, for authentication of a device (not shown), with which the authentication device 100 is associated. In this example, the operation of the authentication device 100 of FIG. 2 is substantially identical to that of the authentication device 10 of FIG. 1, save that the authentication process is started by an activation signal 130 sent over a network connection by a remote server (not shown), instead of being started by a user pressing the button 30, and the authentication code is sent as an output signal 160 over the network connection to the server.

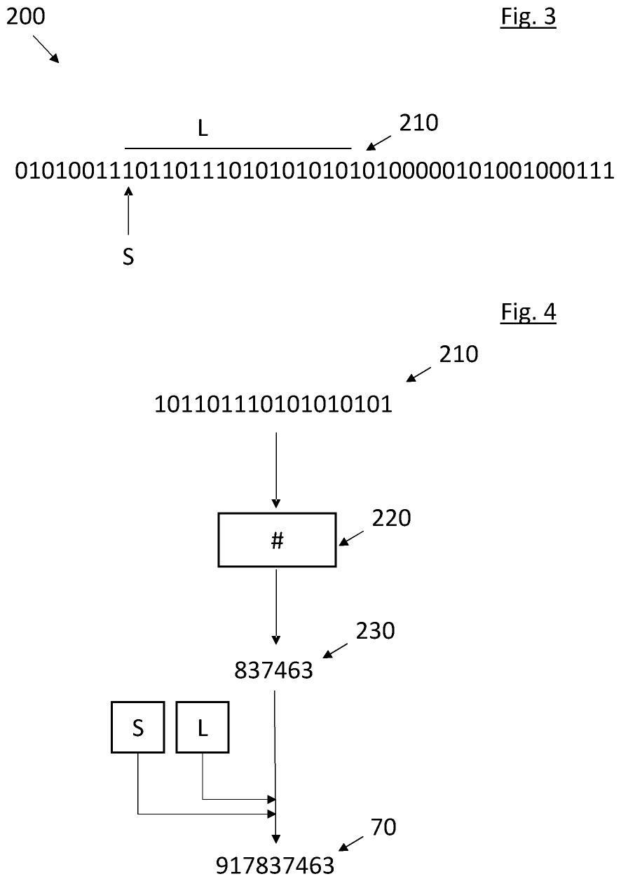

Generation of the authentication code is illustrated in schematic form in FIGS. 3 and 4. The EEPROM 20 stores the one-time pad 200 as a sequence of 1s and 0s. The register 50 stores a starting address S and the processor 40 generates a random length L (FIGS. 3 and 4 show the length L as being only 18 bits, for ease of illustration, but in general it will be much longer). The processor 40 retrieves the bits 210 from the one time pad that start at the starting address S and extend for the length L. As shown in FIG. 4, the retrieved bits 210 are subjected to a hash 220 that results in a sequence 230 of numbers. The starting address S and length L are concatenated with the sequence 230 of numbers to produce the authentication code 70.

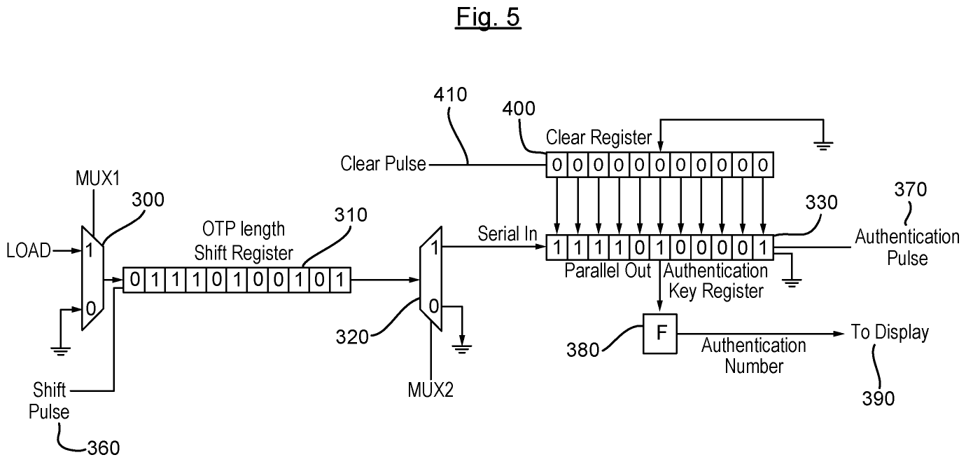

FIG. 5 shows how three shift registers 310, 330, 400 can be used in an example implementation of the invention. A first multiplexer 300 is connected (high input 1) to a load, ground (low input 0) and to an OTP shift register 310. Although, for ease of illustration, OTP shift register 310 is shown in FIG. 5 as having only 11 bits, in reality it will be very much larger, as it contains the bits of the OTP. The shift registers 310, 330, 400 may be implemented as a single (large) register or as a plurality of smaller shift registers connected in series. The OTP shift register 310 is connected to a second multiplexer 320, which is connected as a demultiplexer, with a low output 0 connected to ground and a high output 1 connected to an authentication key register 330. Each bit of the authentication key register 330 is connected to receive bits from a clear register 400, which is populated with 0s (i.e. connected to ground).

The load includes a source of random numbers, which are passed into the OTP shift register 310 when the first multiplexer 300 is switched high by a signal MUX1. The second multiplexer 320 is enabled or disabled by a signal MUX2; when the signal MUX2 switches the second multiplexer 320 low “0”, the second multiplexer 320 is connected to ground, and when the signal MUX2 switches the second multiplexer 320 high “1”, bits can flow from the OTP shift register 310 to the authentication key register 330. The bits of the authentication key register 330 are set to “0” when a clear pulse 410 is sent to the clear register 400. The bits of the authentication key register 330 are used to generate an authentication number in a hash function module 380 when an authentication pulse 370 is sent to the authentication key register. The authentication number is sent to a display 390 so that the user can read it and transmit it to an authentication server (not shown).

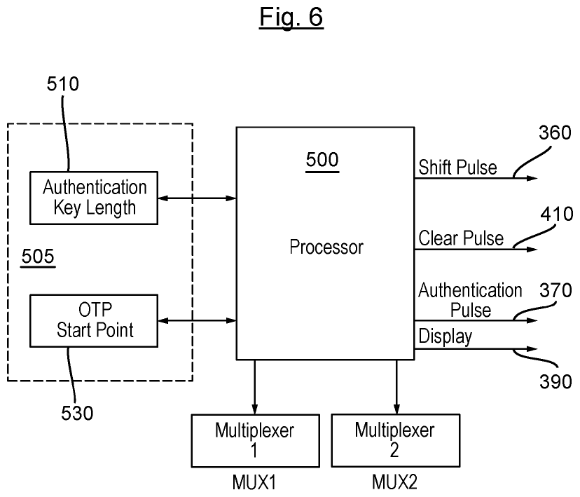

The operation of the shift registers 310, 330, 400 is controlled by a processor 500 (FIG. 6). The processor 500 is connected to a memory 505 storing an authentication key length value 510 and an OTP start point value 530. The processor is connected to generate the enable/disable signals MUX1 and MUX2. The processor 500 is also arranged to generate the shift pulse 360, clear pulse 410 and authentication pulse 370, and to send to the display 390 the authentication number, authentication key length 510, and OTP start point value 530.

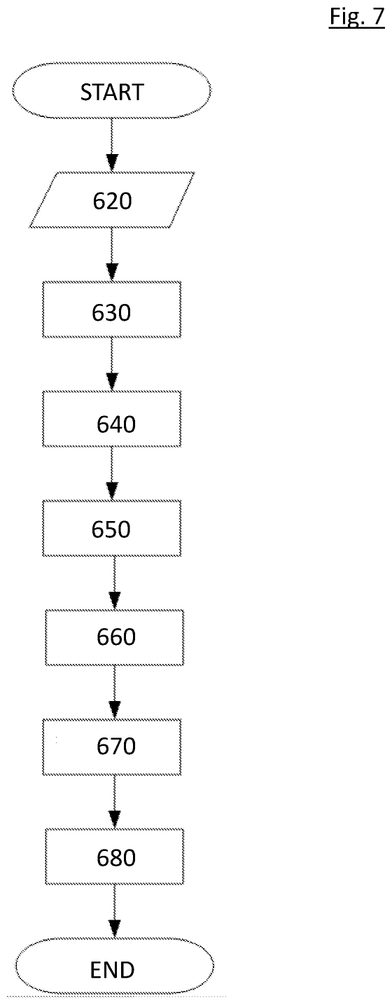

In an example method of remote authentication (FIG. 7), the processor 500 receives (step 620) a request for an authentication code 380. The processor sets (step 630) MUX2 to 1 and reads (step 640) the authentication key length value 510 from memory. The processor 500 sends (step 650) a number of shift pulses 360 to the OTP shift register 310, the number being equal to the authentication key length value 510. That shifts that number of bits from the OTP shift register 310 to the authentication key register 330. The processor 500 then sends (step 660) an authentication pulse 370 to the authentication key register 330. All of the bits stored in the authentication key register are released in parallel to the hash function module 380, where they are used to generate the authentication number (in a manner well known in the art). The processor 500 sends the authentication number to the display 390, together with the authentication key length value 510. The processor 500 also sends (step 670) the OTP start point value 530. The processor 500 then uses the start point value 530 and the authentication key length value 510 to calculate a new start point value 530, which the processor writes to the memory (680).

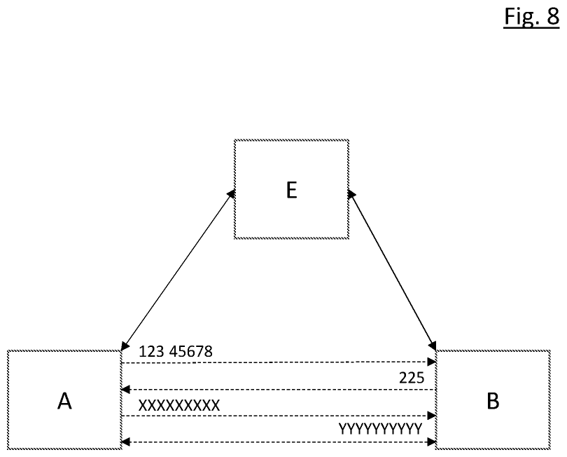

FIG. 8 shows how an example embodiment of the present invention can prevent a so-called “man in the middle” attack. A and B want to communicate securely.

However, E has compromised A's laptop, which is being used to input an authentication code for transmission to B. E therefore has access to the authentication code.

A sends B the start point (in this example 123) used for the authentication code of the OTP for A, together with the authentication code itself (45678). B receives the start point and generates the authentication code corresponding to that start point in its own OTP. If the code generated matches the number received, then B sends a new start point (225) to A to synchronize and requests a set of bits to authenticate. (The new start point will be greater than or equal to A′s current start point.) A encrypts a set of bits (XXXXXXXXX) using the OTP start point sent from B to confirm authenticity with B. B encrypts the bits at the start point it transmitted in its own OTP compares the result with those sent by A. If the bits are equal then authentication is complete and encrypted exchange of information (YYYYYYYYY) begins.

E knows the start point (123) in the OTP, but is unable to send the correct bits (XXXXXXXXX) encrypted by A using the start point specified by B, because E does not have access to the OTP; hence E cannot present herself as A.

The use of an OTP to authenticate users is quantum resistant as the bits used to generate the hashes are only used once. The device only requires one factor which is the OTP key itself.

A new OTP can be provided by sending out a new module to the user (or installing a new module into the device), or by updating the key via software.

However, in practice, a relatively small SD card could hold an OTP such that the hardware would fail before the OTP is fully consumed.

In embodiments where the device deletes the bits after (or as) they have been used, the risk of the reliability of the authentication process being compromised by capture of the device is reduced. Deleting the bits also protects against hardware errors that may cause erroneous reuse of bits.

While the present disclosure has been described and illustrated with reference to particular embodiments, it will be appreciated by those of ordinary skill in the art that the disclosure lends itself to many different variations not specifically illustrated herein.

For example, in some embodiments of the invention, a personal pin is used to authenticate the device to a user or additional device, thus preventing a captured device from being used. Normal security procedures can be implemented such as device wipe after a number of incorrect inputs.

Although in the device-authenticating example of FIG. 2 the starting point, pseudo key length and hash are generated in the same way as in the person-authenticating example of FIG. 1, in alternative embodiments, an automated process can be used to generate them when queried to do so. In an example implementation, each time a request for an authentication key occurs using the OTP module, the start bit of the OTP will increase. The starting point is stored in a register and the increment will be the same as the bit length chosen for the authentication key. In the OTP Module, the processor can read and write to the start point value. As the key length is customizable the range of bits used will differ so the increment will have to match the key length used. A default value will be loaded that will increment by that amount however this can be modified.

The above examples use short sequence lengths for ease of explanation and illustration; however, it will be appreciated that embodiments of the invention will typically employ OTPs and authentication codes that are very much longer.

It would be readily appreciated that in alternative embodiments the remote authentication device 10 is included in a smart card, such as a credit card. Currently, such cards utilize a chip and pin or contactless RFID as a method of utilizing a public/private key system to authenticate a user. The user of the smart card authenticates themselves with payment machines such as ATMs and Point of Sale card readers. Like RSA, the public/private algorithms currently available are vulnerable to quantum computing. Therefore, the implementation of a one-time pad as described above could be used as an alternative to public/private keys for smart card authentication.

Whilst the accompanying drawings show decimal and binary numbers, it will be appreciated that embodiments of the invention may utilize other numbers, for example hexadecimal numbers, alphanumeric symbols or other data types.

Where, in the foregoing description, integers or elements are mentioned that have known, obvious, or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as optional do not limit the scope of the independent claims. Moreover, it is to be understood that such optional integers or features, while of possible benefit in some embodiments of the disclosure, may not be desirable, and can therefore be absent, in other embodiments.

1. A method of remote authentication, comprising:
(i) either:
transmitting a start point of a one time pad; or
receiving a start point of a one time pad; and
(ii) forming a key from a plurality of bits from the one time pad, wherein the first one of the plurality of bits is at the start point;
(iii) using the key to generate an authentication code;
(iv) receiving an authentication code;
(v) performing the authentication by comparing the generated authentication code with the received authentication code; and
(vi) repeating steps (i) to (v) a plurality of times using a different plurality of bits from the one time pad.

2. A method of remote authentication, comprising:
either:
(i) receiving a start point of a one time pad; or
transmitting a start point of a one time pad; and
(ii) forming a key from a plurality of bits from the one-time pad, wherein the first one of the plurality of bits is at the start point;
(iii) using the key to generate an authentication code;
(iv) transmitting the authentication code; and
(v) repeating steps (i) to (iv) a plurality of times using a different plurality of bits from the one time pad.

3. The method of claim 1, in which the authentication code is generated by: using the key in a hash; applying a logical operation to the key and a plurality of bits from the OTP, the plurality of bits not forming the key; or forming the authentication code directly from the key.

4. The method of claim 1, including the step of recording a current start point in the one time pad, from which the plurality of bits is retrieved, and then updating the current start point to be the bit next following the retrieved bits in the one time pad.

5. The method of claim 2, including the steps of, subsequent to generating the authentication code, forming an encryption key from a plurality of bits, different from those used to form the authentication code, from the one time pad and using the encryption key to encrypt a message.

6. The method of claim 2, in which the authentication code is transmitted in plaintext.

7. The method of claim 1, in which the bits used to form the key are deleted automatically from the one time pad.

8. The method of claim 2, in which different length keys are formed in different iterations of steps (i) to (iii) and the key length is transmitted, as part of or in addition to the authentication code.

9. The method of claim 1, in which the plurality of bits used to form the key is retrieved from a contiguous portion of the one time pad.

10. A remote authentication device, comprising:
(i) a memory including a one time pad comprising a series of bits;
(ii) circuitry arranged to:
a. receive a start point of a one time pad;
b. retrieve a plurality of the bits from the one time pad, wherein a first one of the plurality of bits is at the start point of the one time pad,
c. form a key from the plurality of bits,
d. use the key to generate an authentication code,
e. repeat steps (a) to (d) a plurality of times using a different plurality of bits from the one time pad.

11. The device of claim 10, wherein the circuitry is arranged to transmit the authentication code.

12. The device of claim 10, wherein the circuitry is arranged to receive an authentication code and to perform an authentication by comparing the generated authentication code with the received authentication code.

13. The device of claim 10, including a serial shift register, wherein:
the one time pad is loaded into the serial shift register;
the bits forming the key are shifted from the serial shift register; and
the bits left vacant by the shifting are populated with zeros, ones or a random or pseudo-random sequence of zeros and ones.

14. The device of claim 10, including a display and configured to present the authentication code to a user on the display.

15. The device of claim 10, wherein the start point in the one-time pad and a key length are generated automatically when the device receives a query across a network connection.

16. A smart card comprising the remote authentication device according to claim 10.

17. The method of claim 2, in which the authentication code is generated by: using the key in a hash; applying a logical operation to the key and a plurality of bits from the OTP, the plurality of bits not forming the key; or forming the authentication code directly from the key.

18. The method of claim 2, including the step of recording a current start point in the one time pad, from which the plurality of bits is retrieved, and then updating the current start point to be the bit next following the retrieved bits in the one time pad.

19. The method of claim 2, in which the bits used to form the key are deleted automatically from the one time pad.

20. The method of claim 5, in which different length keys are formed in different iterations of steps (i) to (iii) and the key length is transmitted, as part of or in addition to the authentication code.
